(19) United States
(12) Patent Application Publication
(10) Pub. No.: US 2021/0179216 A1
(43) Pub. Date: Jun. 17, 2021

(54) TRIANGULAR BIKE STAND

(71) Applicant: Curtis A. Henricksen, Murieta, CA (US)

(72) Inventor: Curtis A. Henricksen, Murieta, CA (US)

(21) Appl. No.: 17/123,593

(22) Filed: Dec. 16, 2020

Related U.S. Application Data
(60) Provisional application No. 62/948,682, filed on Dec. 16, 2019.

(51) Int. Cl. B62H 3/10

(52) U.S. Cl. CPC B62H 3/10

(57) ABSTRACT

A support stand for supporting a bicycle includes an outer surface, a fork, and a lower support surface. The fork includes a first side surface, an opposing second side surface, and a bottom surface extending between the first and second side surfaces. The first side surface, the second side surface, and the bottom surface collectively define a channel offset from the outer surface and being sized and configured to receive a portion of the bicycle. A lower support surface is spaced from the fork and angled relative to the outer surface by 30-60 degrees.

### CROSS-REFERENCE TO RELATED APPLICATIONS

This application claims the benefit of U.S. Application Ser. No. 62/948,682, filed Dec. 16, 2019, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a support stand for a bicycle, and more specifically to a support stand capable of supporting the bicycle without being directly mounted to the bicycle.

### 2. Description of the Related Art

Bicycles are widely used as a means of transportation, as well as for recreational purposes. When a bicycle is not being used, it is common to leave the bicycle in a generally upright position. Along these lines, many municipalities or commercial properties may include bicycle racks with vertical posts against which a user may lean the bicycle to park the bicycle. Some bicycle may also include kickstands mounted directly to the bicycle frame. The kickstand may pivot relative to the frame between a stowed position and a deployed position. When in the deployed position, the kickstand may provide a structure on which the bicycle may lean against. During use of the bicycle, the kickstand may be transitioned to the stowed position so as not to drag on the ground.

While conventional kickstands allow bicycles to remain in a titled, upright position when not being ridden by a user, some bicycles do not include a kickstand. Along these lines, some bicycles used in races do not include integrated kickstands to reduce the overall weight of the bicycle. Furthermore, mountain bikers may not prefer an integrated kickstand because the kickstand can become caught in vegetation along a trail. Furthermore, the aggressive riding which may be associated with mountain bike trails may cause an integrated kickstand to rattle, which may be an annoyance to the biker.

Therefore, there is a need in the art for a support stand for a bicycle that can be used to support a bicycle in a titled, upright position, without being directed connected to the bicycle. Various aspects of the present disclosure address this particular need, as will be described in more detail below.

### BRIEF SUMMARY

According to one embodiment, there is provided a support stand for supporting a bicycle. The support stand generally includes an outer surface, a fork, and a lower support surface. The fork includes a first side surface, an opposing second side surface, and a bottom surface extending between the first and second side surfaces. The first side surface, the second side surface, and the bottom surface collectively define a channel offset from the outer surface and being sized and configured to receive a portion of the bicycle. A lower support surface is spaced from the fork and angled relative to the outer surface by 30-60 degrees.

The outer surface may include a lower edge and a pair of side edges extending from the lower edge and angled toward each other as they extend away from the lower edge.

The first and second side surfaces of the fork may be parallel to the outer surface. The bottom surface of the fork may be perpendicular to the outer surface.

The lower support surface may be spaced from the outer surface. The lower support surface may be angled relative to the outer surface by 45 degrees.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an upper perspective view of a support stand for supporting a bicycle;

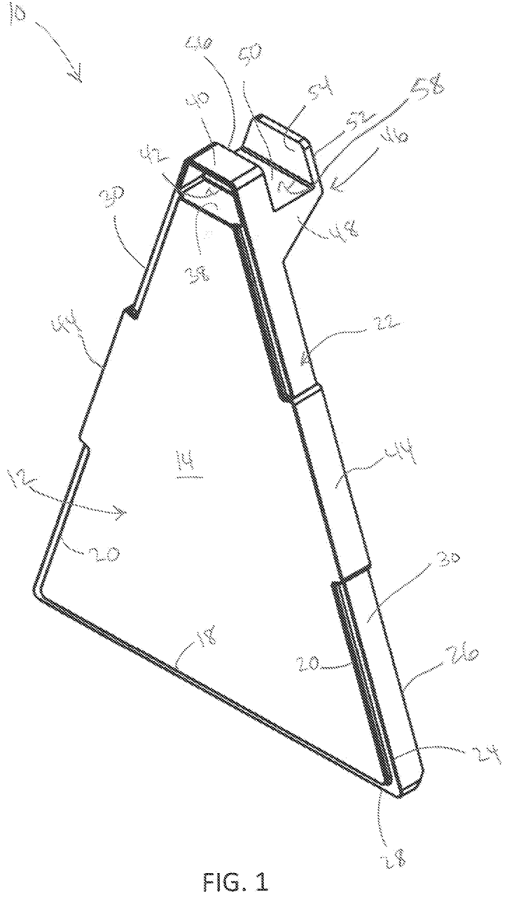

FIG. 2 is a front view of the support stand shown in FIG. 1;

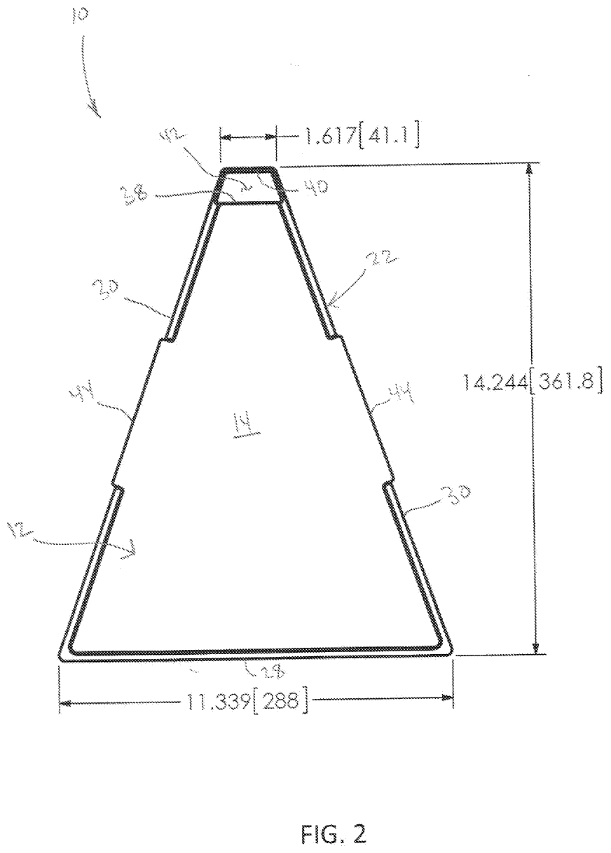

FIG. 3 is a rear view of the support stand shown in FIG. 1;

FIG. 4 is a side view of the support stand shown in FIG. 1;

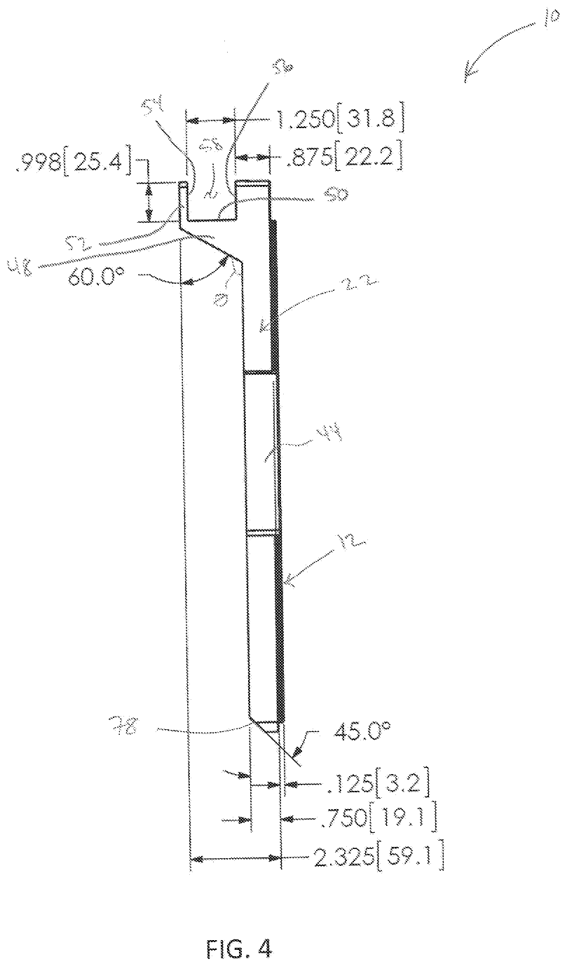

FIG. 5 is a top view of the support stand shown in FIG. 1; and

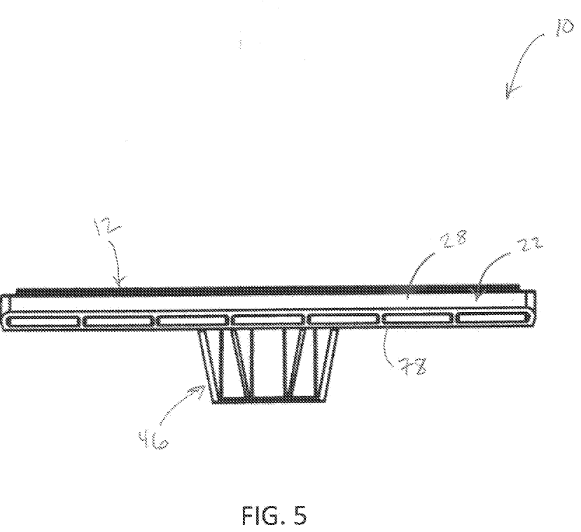

FIG. 6 is a side view of an exemplary bicycle which may be used with the support stand.

### DETAILED DESCRIPTION

Referring now to the drawings, wherein the showings are for purposes of illustrating preferred embodiments of the present disclosure only, and are not for purposes of limiting the same, there is depicted a support stand 10 separate from a bicycle, yet configured for supporting a bicycle in a generally upright position, e.g., with one or both wheels on the ground and the handlebars elevated above the ground. In this regard, the support stand 10 may be particularly advantageous for bicycles that do not include an integrated kickstand. The support stand 10 may be used on a regular basis for storing the bicycle, for supporting the bicycle when performing maintenance on the bicycle, or for supporting the bicycle on-the-go. The design of the support stand 10 allows for ease of use and transport thereof while also providing a desirable appearance.

According to one embodiment, the support stand 10 may include a generally triangular body, with the bottom/base of the triangle being configured to be disposable on the ground, and an upper/apex portion of the triangle being configured to engage with the bicycle. The support stand 10 may include a primary wall 12 including an outer surface 14 and an opposing inner surface 16. The outer surface 14 may include a lower edge 18 and a pair of side edges 20 extending from the lower edge 18 and angled toward each other as they extend away from the lower edge 18. It is contemplated that indicia, names, logos, etc., may be printed, adhered, laminated or otherwise formed on the outer surface 14.

The primary wall 12 may be surrounded by an outer peripheral wall 22 having a forward facing edge 24 and a rearward facing edge 26 to define a peripheral wall thickness therebetween. The forward facing edge 24 may be slightly recessed behind the primary wall 12. According to one embodiment, the peripheral wall thickness may be approximately 0.750 inches, although the peripheral wall thickness may vary without departing from the spirit and scope of the present disclosure. The outer peripheral wall 22 may include a lower wall portion 28, and a pair of side portions 30, which are complementary peripheral contours of the primary wall 12, although slightly greater in size.

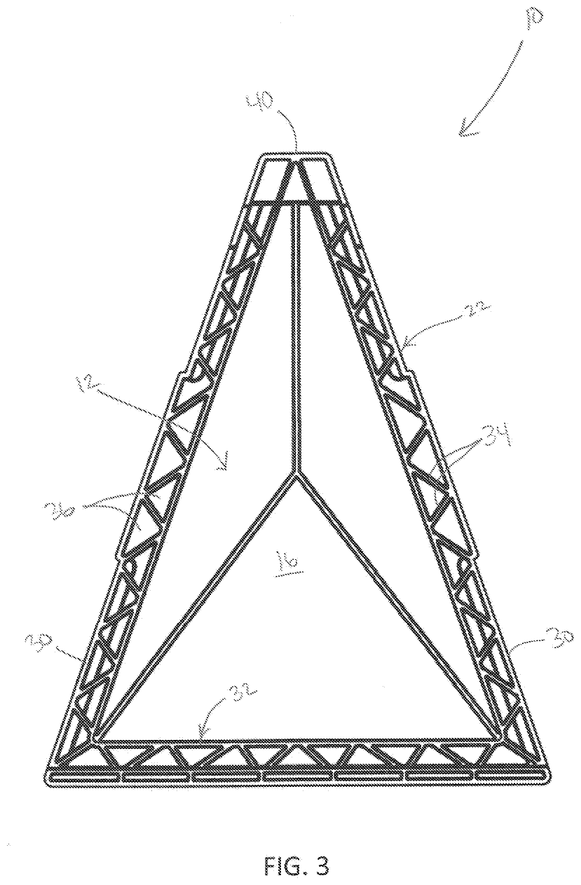

Referring now to FIG. 3, which is a rear view of the support stand 10, there is shown an inner peripheral wall 32 which may extend behind the primary wall 12 and inwardly from the outer peripheral wall 22. A plurality of support ribs 34 may extend between the outer and inner peripheral walls 22, 32. The ribs 34 may also be angled relative to each other to define a plurality of triangular shaped cavities 36 or recesses. The ribs 34 may enhance the structural integrity of the support stand 10, particularly for supporting the weight of a bicycle supported by the support stand 10, while the cavities 36 result in a reduction of material to lower manufacturing costs, as well as the overall weight of the support stand 10.

Both the primary wall 12 and outer peripheral wall 22 may include a generally planar upper portion, as opposed to a sharp, pointed tip. More specifically, the primary wall 12 may include a primary upper surface 38 and the outer peripheral wall 22 may include a peripheral upper wall portion 40. The primary upper surface 38 and peripheral upper wall portion 40 may be disposed in spaced, generally parallel relation to each other so as to partially define an upper cavity 42 therebetween. The upper cavity 42 may also be partially defined by upper segments of the side portions 30 of the outer peripheral wall 22. The upper cavity 42 may provide a finger grip for a user to hold onto the support stand 10.

The support stand 10 may include a pair of side protrusions 44, each of which extend rearwardly from respective sides of the primary wall 12, and outwardly from a respective side portion 30 of the outer peripheral wall 22. The side protrusions 44 may be generally coextensive in width with the outer peripheral wall 22 and may be positioned over a middle region of the respective side portion 30 of the outer peripheral wall 22. The side protrusions 44 may provide an enhanced, robust appearance to the support stand 10.

The support stand 10 may additionally include a fork 46 configured to directly engage with the bicycle. According to one embodiment, the fork 46 includes a cantilevered arm 48 extending from the outer peripheral wall 22 and defining a bottom surface 50 of the fork 46. The cantilevered arm 48 may extend at an angle θ relative to the outer peripheral wall 22. The angle θ may be greater than ninety degrees, and in one particular embodiment, equal to approximately 120 degrees. Extending upwardly from a distal end of the cantilevered arm 48 is a fork side wall 52 including a first side surface 54. The fork 46 additionally includes a second side surface 56 opposite the first side surface 54. The first and second side surfaces 54, 56 are spaced from each other, with the bottom surface 50 extending between the first and second side surfaces 54, 56. The first and second side surfaces 54, 56 of the fork 46 may be parallel to the outer surface 14, and the bottom surface 50 of the fork 46 may be perpendicular to the outer surface 14. However, it is contemplated that the side surfaces 54, 56 and the bottom surface 50 of the fork 46 may define other shapes, such as a concave shape, without departing from the spirit and scope of the present disclosure.

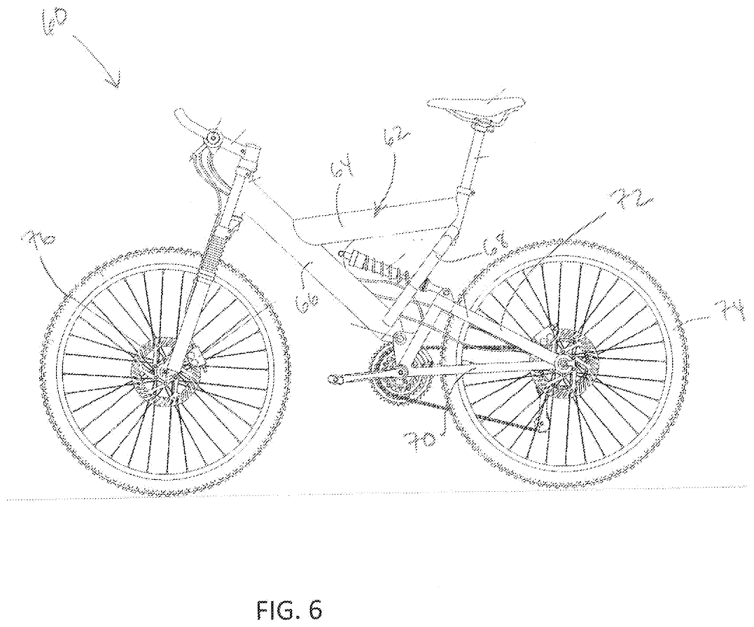

The first side surface 54, the second side surface 56, and the bottom surface 50 collectively define a channel 58 sized and configured to receive a portion of the bicycle 60. Referring now to FIG. 6, there is shown an exemplary bicycle 60 which may be used with the support stand 10. The bicycle 60 includes a frame 62 including a top tube 64, a down tube 66, a seat tube 68, chain stays 70, and seat stays 72. The frame 62 is connectable to a rear wheel 74 and a front wheel 76. The aforementioned components of the frame 62 are included in most bicycles, including but not limited to mountain bicycles, road bicycles, beach cruisers, BMX bicycles, children's bicycles, push bicycles, scooter bicycles, electric bicycles, etc. In this regard, as used herein, the term bicycle 60 is used broadly to refer to any species of bicycle.

According to one embodiment, the support stand 10 is sized and configured to engage with one of the chain stays 70 on the bicycle frame 62. In this regard, the channel 58 on the support stand 10 may be sized to receive the chain stay 70 to support the bicycle 60 in a raised position. When the chain stay 70 is received in the channel 58, the chain stay 70 may engage with the bottom surface 50 of the fork 46, and the first and second side surfaces 54, 56 may extend on opposite sides of the chain stay 70.

While the top portion of the support stand 10 engages with the bicycle 60, the bottom portion of the support stand 10 engages with the ground. In this regard, the support stand 10 may include a lower support surface 78 adapted to contact the ground. The lower support surface 78 may angled relative to the outer surface 14 by 30-60 degrees. In one particular embodiment, the lower support surface 78 may be angled relative to the outer surface 14 by 45 degrees. The angle of the lower support surface 78 allows the support stand 10 to extend between the ground and the bicycle 60 at an angle to support the bicycle 60 in a manner similar to a conventional kickstand. For instance, the primary wall 12 may extend at a 45 degree angle relative to the ground when the lower support surface 78 lies flush on the ground. It is contemplated that the lower support surface 78 may be configured to enhance the friction with the ground, and thus, an anti-skid surface or coating (e.g., rubber) may be applied thereto.

It is contemplated that the support stand 10 may be molded as a unitary structure, and may be formed from a polymer material, or other materials known in the art. It is also contemplated that the primary wall 12, outer peripheral wall 22, and fork 46 may be separate structures which are fastened together using screws, rivets, adhesives or other fasteners known in the art. In this regard, the primary wall 12 may be formed from a material that differs from that of the outer peripheral wall 22 and fork 46. For instance, the primary wall 12 may be formed from a metallic material, while the outer peripheral wall 22 and fork 46 may be formed from a polymer material.

Although the exemplary embodiment of the support stand 10 includes a primary wall 12, it is contemplated that other embodiments may be formed without the primary wall 12. In this regard, such alternate embodiments may simply include a peripheral support unit, e.g., the outer peripheral wall 22, inner peripheral wall 32, and support ribs 34, the fork 46, and the lower support surface 78. Thus, the peripheral support unit may be strong enough to support the load of the bicycle 60 without being compromised.

With the basic structure of the support stand 10 described above, the following discussion relates to an exemplary use of the support stand 10. To use the support stand 10, a user may hold the bicycle 60 in a generally upright position, e.g., the rotation axes of the wheels being generally perpendicular to the ground, and position the support stand 10 adjacent the bicycle 60. The support stand 10 is then moved to position or align the chain stay 70 of the bicycle 60 within the channel 58 on the support stand 10, such that the chain stay 70 is positioned between the first and second side surfaces 54, 56 of the fork 46. The bicycle 60 may be slightly tilted to one side, until the lower support surface 78 contacts the ground. When the lower support surface 78 has solid contact with the ground, and the support stand 10 extends between the ground the bicycle 60, the user may let go of the bicycle 60. The weight of the bicycle 60 will be transferred to the ground at the wheels of the bicycle 60, as well as the support stand 10. In this regard, the support stand 10 helps to support the bicycle 60 when the bicycle 60 is leaning slightly to one side, such that the rotation axes of the wheels are non-parallel to the ground. As the weight of the bicycle 60 presses against the support stand 10, the weight may cause the support stand 10 to experience a compressive force, although the material properties of the support stand 10 are configured to withstand such force. The compressive force may additionally increase the friction between the lower support surface 78 and the ground to maintain the position of the lower support surface 78 relative to the ground. Furthermore, as the bicycle 60 is leaning against the support stand 10, the friction between the bicycle wheels and the ground also stabilizes the upright bicycle 60. Thus, with the support stand 10 extending between the ground and the chain stay 70, the bicycle 60 may be maintained in the titled, upright position.

While the bicycle 60 is supported by the support stand 10, the user may inspect the bicycle 60 or perform maintenance on the bicycle 60. For instance, the user may inflate the tires, grease the bicycle chain, etc. Alternatively, the user may leave the bicycle 60 supported by the stand during periods of non-use. When the user wants to use the bicycle 60, the user may lift the bicycle 60 from the tilted position, which removes the force of the bicycle 60 applied to the support stand 10. As such, the support stand 10 is no longer captured between the bicycle 60 and the ground. The user may grip the support stand 10 by inserting one or more fingers into the cavity to grab onto the support stand 10 to put the support stand 10 away.

The support stand 10 provides an easy-to-use alternative to bicycle-mounted kickstands. Furthermore, the support stand 10 may be small enough to be stowed in a backpack or similar gear, to use to the support stand 10 on-the-go. In this regard, should the user need to temporarily park the bicycle 60, the support stand 10 may be retrieved from the backpack and used to support the bicycle 60.

Any dimensions mentioned herein or included in the drawings are exemplary in nature, and thus, do not limit the scope of the present disclosure. In this regard, it is contemplated that the support stand 10 may be formed in other sizes and other configurations having different dimensional properties. Furthermore, it is understood that any dimension may be associated with industry standard manufacturing tolerances.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A support stand for supporting a bicycle, the support stand comprising:
an outer surface;
a fork including a first side surface, an opposing second side surface, and a bottom surface extending between the first and second side surfaces, the first side surface, second side surface, and bottom surface collectively defining a channel offset from the outer surface and being sized and configured to receive a portion of the bicycle; and
a lower support surface spaced from the fork and angled relative to the outer surface by 30-60 degrees.

2. The support stand recited in claim 1, wherein the outer surface includes a lower edge and a pair of side edges extending from the lower edge and angled toward each other as they extend away from the lower edge.

3. The support stand recited in claim 1, wherein the first and second side surfaces are parallel to the outer surface.

4. The support stand recited in claim 1, wherein the bottom surface of the fork is perpendicular to the outer surface.

5. The support stand recited in claim 1, wherein the lower support surface is spaced from the outer surface.

6. The support stand recited in claim 1, wherein the lower support surface is angled relative to the outer surface by 45 degrees.
